(19) United States
(12) Patent Application Publication
(10) Pub. No.: US 2025/0124351 A1
(43) Pub. Date: Apr. 17, 2025

(54) COMPUTER-READABLE RECORDING MEDIUM STORING TASK CONTROL PROGRAM, INFORMATION PROCESSING APPARATUS, AND TASK CONTROL METHOD

(71) Applicant: Fujitsu Limited, Kawasaki-shi (JP)

(72) Inventor: Mariko KASE, Yokohama (JP)

(73) Assignee: Fujitsu Limited, Kawasaki-shi (JP)

(21) Appl. No.: 18/897,047

(22) Filed: Sep. 26, 2024

(30) Foreign Application Priority Data
Oct. 13, 2023 (JP) 2023-177690

(51) Int. Cl. G06N 20/00

(52) U.S. Cl. CPC G06N 20/00

(57) ABSTRACT

A non-transitory computer-readable recording medium stores a task control program for causing a computer to execute a process including: executing automated machine learning (AutoML) processing on each of a plurality of tasks to acquire a plurality of pipelines for each of the plurality of tasks; classifying the plurality of tasks into a plurality of groups based on similarities of one or more pipelines selected based on evaluation values, among the plurality of pipelines, and similarities of evaluation values of the one or more pipelines; and generating a task group by selecting one task from each of the plurality of groups based on an execution time of the AutoML processing of each of the plurality of tasks.

### CROSS-REFERENCE TO RELATED APPLICATION

This application is based upon and claims the benefit of priority of the prior Japanese Patent Application No. 2023-177690, filed on Oct. 13, 2023, the entire contents of which are incorporated herein by reference.

### FIELD

The embodiment discussed herein is related to a computer-readable recording medium storing a task control program, an information processing apparatus, and a task control method.

### BACKGROUND

Although momentum of data utilization has been increasing, data scientists are insufficient. In such a circumstance, Automated Machine Learning (AutoML) that may be handled by non-engineers and beginner data scientists has been attracting attention.

International Publication Pamphlet No. WO 2014/118938 and Japanese Laid-open Patent Publication No. 2008-107896 are disclosed as related art.

### SUMMARY

According to an aspect of the embodiments, a non-transitory computer-readable recording medium stores a task control program for causing a computer to execute a process including: executing automated machine learning (AutoML) processing on each of a plurality of tasks to acquire a plurality of pipelines for each of the plurality of tasks; classifying the plurality of tasks into a plurality of groups based on similarities of one or more pipelines selected based on evaluation values, among the plurality of pipelines, and similarities of evaluation values of the one or more pipelines; and generating a task group by selecting one task from each of the plurality of groups based on an execution time of the AutoML processing of each of the plurality of tasks.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a hardware configuration example of an information processing apparatus according to an embodiment;

FIG. 2 is a block diagram schematically illustrating a software configuration example of the information processing apparatus illustrated in FIG. 1;

FIG. 3 is a block diagram schematically illustrating a configuration example of a pipeline degree-of-similarity determination unit illustrated in FIG. 2;

FIG. 4 is a block diagram schematically illustrating a configuration example of a benchmark selection unit illustrated in FIG. 2;

FIG. 5 is a diagram for describing task control processing according to the embodiment;

FIG. 6 is a flowchart for describing processing of determining a degree of similarity of a pipeline according to the embodiment;

FIG. 7 is a flowchart for describing processing of selecting a benchmark according to the embodiment;

FIG. 8 is a block diagram schematically illustrating a configuration example of a pipeline degree-of-similarity determination unit according to a modification example;

FIG. 9 is a table representing an execution result example of all benchmark tasks according to the modification example;

FIG. 10 is a diagram for describing processing of determining a degree of similarity of a pipeline according to the modification example;

FIG. 11 is a diagram for describing processing of creating a sub-group from a deviation between evaluation values of pipelines according to the modification example;

FIG. 12 is a diagram for describing processing of creating a sub-group based on degrees of similarity of optimum values of hyper parameters of a machine learning model according to the modification example; and

FIG. 13 is a flowchart for describing processing of determining a degree of similarity of a pipeline according to the modification example.

### DESCRIPTION OF EMBODIMENTS

AutoML outputs appropriate machine learning pipelines for input data and tasks. A task is an item set by a user such as “which column of data is set as a target to be estimated” or “whether an estimation method is classification or regression”. AutoML is assumed to be used in various domains, and a capability of outputting appropriate pipelines for various data and tasks is to be presented in order to evaluate the generalized performance thereof. Benchmark data and task sets are used at this time.

Since AutoML itself has evolved daily, the benchmark data and task sets are executed frequently.

However, since the amount of benchmark data and task sets is large, execution takes cost (for example, time and calculation resources).

In one aspect, an object is to shorten time for evaluating generalization performance of AutoML.

### [A] Embodiment

Hereinafter, an embodiment will be described with reference to the drawings. However, the following embodiment is merely exemplary, and it is not intended to exclude various modification examples or technical applications that are not explicitly described in the embodiment. For example, the present embodiment may be implemented by variously modifying the present embodiment within a scope not departing from the gist of the present embodiment. Each drawing is not intended to indicate that only constituent elements illustrated in the drawing are included, and other constituent elements or the like may be included.

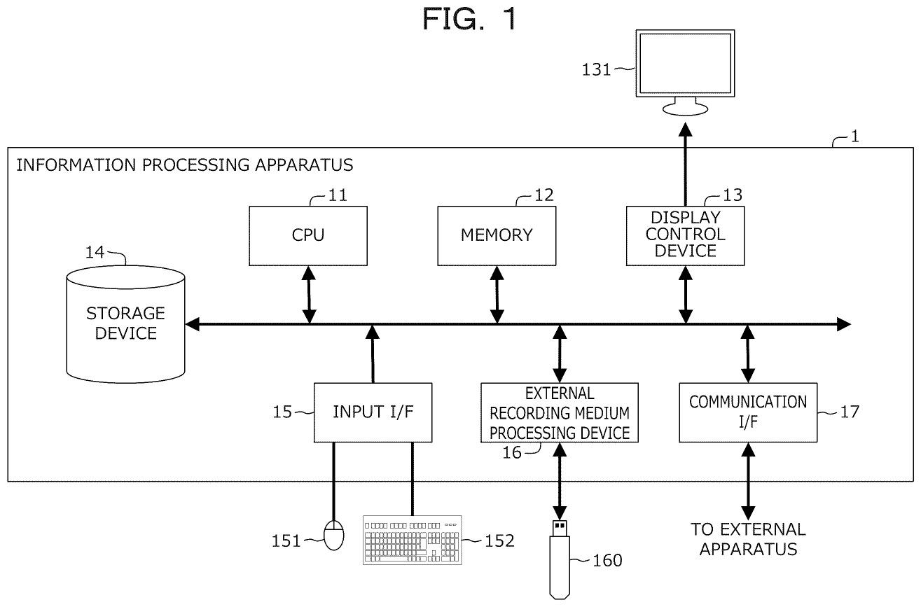

FIG. 1 is a block diagram schematically illustrating a hardware configuration example of an information processing apparatus 1 according to the embodiment.

As illustrated in FIG. 1, the information processing apparatus 1 includes a central processing unit (CPU) 11, a memory 12, a display control device 13, a storage device 14, an input interface (IF) 15, an external recording medium processing device 16, and a communication IF 17.

The memory 12 is an example of a storage unit and includes, for example, a read-only memory (ROM), a random-access memory (RAM), and the like. Programs such as a Basic Input/Output System (BIOS) may be written in the ROM of the memory 12. A software program in the memory 12 may be loaded and executed by the CPU 11 as appropriate. The RAM of the memory 12 may be used as a temporary recording memory or as a working memory.

The display control device 13 is coupled to a display device 131 and controls the display device 131. The display device 131 is a liquid crystal display, an organic light-emitting diode (OLED) display, a cathode ray tube (CRT) display, an electronic paper display, or the like, and displays various kinds of information for an operator or the like. The display device 131 may be a device combined with an input device, and may be, for example, a touch panel. The display device 131 displays various types of information to a user of the information processing apparatus 1.

The storage device 14 is a storage device having high input and output (IO) performance. For example, a dynamic random-access memory (DRAM), a solid-state drive (SSD), a storage class memory (SCM), or a hard disk drive (HDD) may be used as the storage device 14. The storage device 14 stores a measurement result of latency.

The input IF 15 may be coupled to input devices such as a mouse 151 and a keyboard 152 and control the input devices such as the mouse 151 and the keyboard 152. The mouse 151 and the keyboard 152 are an example of the input devices, and the operator performs various input operations via these input devices.

The external recording medium processing device 16 is configured such that a recording medium 160 is attachable thereto. The external recording medium processing device 16 is configured to be able to read information recorded in the recording medium 160 in a state where the recording medium 160 is attached thereto. In this example, the recording medium 160 has portability. For example, the recording medium 160 is a non-transitory recording medium such as a flexible disk, an optical disk, a magnetic disk, a magneto-optical disk, or a semiconductor memory.

The communication IF 17 is an interface that enables communication with an external apparatus.

The CPU 11 is an example of a processor, and is a processing device that performs various types of control and computation. By executing an operating system (OS) and a program loaded into the memory 12, the CPU 11 implements various functions. The CPU 11 may be a multiprocessor including a plurality of CPUs, a multi-core processor including a plurality of CPU cores, or a configuration including a plurality of multi-core processors.

The device that controls operations of the entire information processing apparatus 1 is not limited to the CPU 11 and may be, for example, any one of an MPU, a DSP, an ASIC, a PLD, and an FPGA. The device that controls the operations of the entire information processing apparatus 1 may be a combination of two or more types of a CPU, an MPU, a DSP, an ASIC, a PLD, and an FPGA. The MPU is an abbreviation for a micro-processing unit, the DSP is an abbreviation for a digital signal processor, and the ASIC is an abbreviation for an application-specific integrated circuit. The PLD is an abbreviation for a programmable logic device, and the FPGA is an abbreviation for a field-programmable gate array.

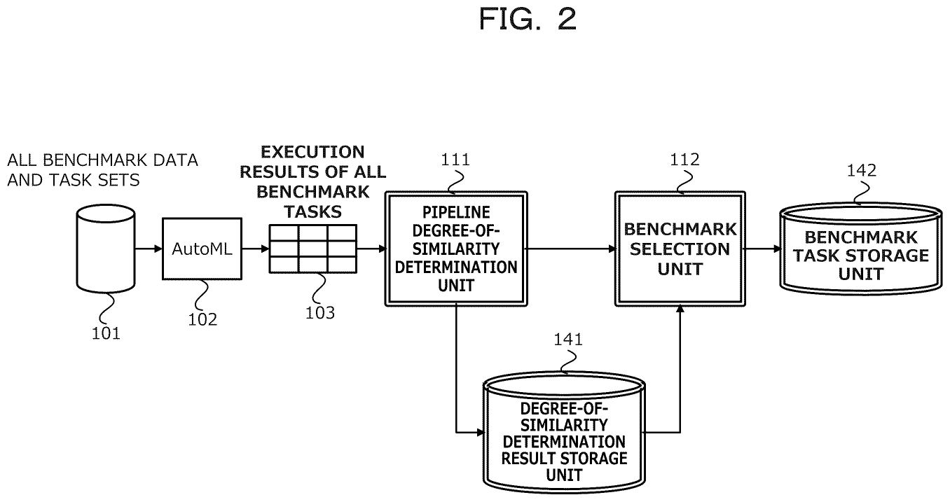

FIG. 2 is a block diagram schematically illustrating a software configuration example of the information processing apparatus 1 illustrated in FIG. 1.

As illustrated in FIG. 2, AutoML 102 uses, as inputs, all benchmark data and task sets 101 and outputs execution results 103 of all benchmark tasks. Data is data in a table format, and has objective variables and feature variables to be solved by machine learning. A task is information such as designation of the objective variable and designation of a problem (regression/classification). For example, a task is a set of table data and information indicating which column of the table is set as the objective variable. A plurality of tasks that are a set of tasks correspond to all the benchmark data and task sets 101.

The execution results 103 of all the benchmark tasks include, for example, an evaluation value of an executed pipeline, an optimum value of a hyper parameter of a machine learning model, and an execution time of each pipeline.

The pipeline that is an output result of the AutoML is a functional block related to preprocessing of data, and may be, for example, missing value filling, encoding of a character string, encoding of a category variable, or a log scale. A functional block related to the machine learning model does not include a hyper parameter (for example, only a type of the model is used for similarity determination of the pipeline), and may be, for example, sk-learnRandomForestClassifier/Regressor, xgboost XGBClassifier/Regressor.

An evaluation index is fixed in the evaluation of the pipeline, and may be, for example, F1 in a case where the task is Classifier, or R2 in a case where the task is Regressor.

A pipeline degree-of-similarity determination unit 111 focuses on machine learning pipelines of past execution results of the AutoML 102, and groups all the benchmark data and task sets 101 (hereafter, referred to as tasks) based on similarity of a pipeline recommended by the AutoML. The pipeline degree-of-similarity determination unit 111 stores determination results of degrees of similarity of the pipelines in a degree-of-similarity determination result storage unit 141. The degree-of-similarity determination result storage unit 141 may be present in the storage device 14 illustrated in FIG. 1.

For example, the pipeline degree-of-similarity determination unit 111 executes AutoML processing on each of the plurality of tasks to acquire a plurality of pipelines for each of the plurality of tasks. The pipeline degree-of-similarity determination unit 111 classifies the plurality of tasks into a plurality of groups based on similarities of one or more pipelines selected based on evaluation values, among the plurality of pipelines, and similarities of evaluation values of the one or more pipelines.

A benchmark selection unit 112 refers to the determination results of the degrees of similarity of the pipelines from the degree-of-similarity determination result storage unit 141, and selects, as the benchmark task, a task having a shortest execution time from each group. The benchmark selection unit 112 stores information on the selected benchmark task in a benchmark task storage unit 142. The benchmark task storage unit 142 may be present in the storage device 14 illustrated in FIG. 1.

For example, the benchmark selection unit 112 generates a task group by selecting one task from each of the plurality of groups based on an execution time of the AutoML processing of each of the plurality of tasks. In a group to which one task belongs, among the plurality of groups, the benchmark selection unit 112 may select, as one task, a task that has a smallest total value of the execution times.

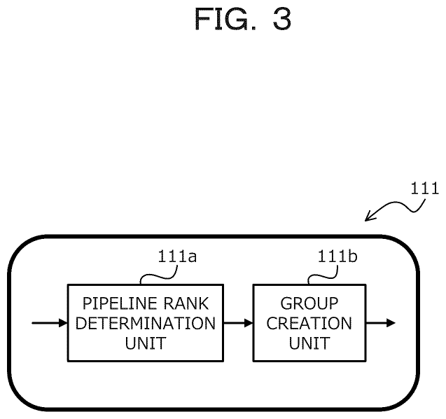

FIG. 3 is a block diagram schematically illustrating a configuration example of the pipeline degree-of-similarity determination unit 111 illustrated in FIG. 2.

The pipeline degree-of-similarity determination unit 111 functions as a pipeline rank determination unit 111a and a group creation unit 111b.

The pipeline rank determination unit 111a ranks the pipelines based on the evaluation values.

The group creation unit 111b sets, as an identical group, tasks having the same top N (N is a natural number) pipelines, among pipelines having good evaluation values ranked by the pipeline rank determination unit 111a.

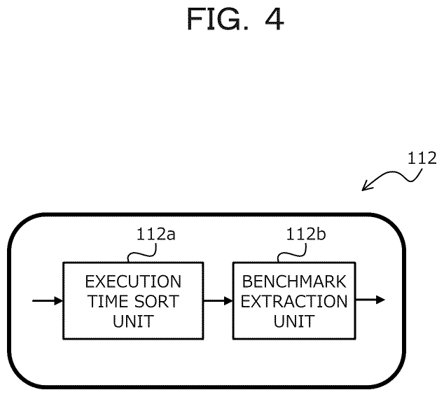

FIG. 4 is a block diagram schematically illustrating a configuration example of the benchmark selection unit 112 illustrated in FIG. 2.

The benchmark selection unit 112 functions as an execution time sort unit 112a and a benchmark extraction unit 112b.

The execution time sort unit 112a sorts the tasks in ascending order of execution time in each group created by the pipeline degree-of-similarity determination unit 111.

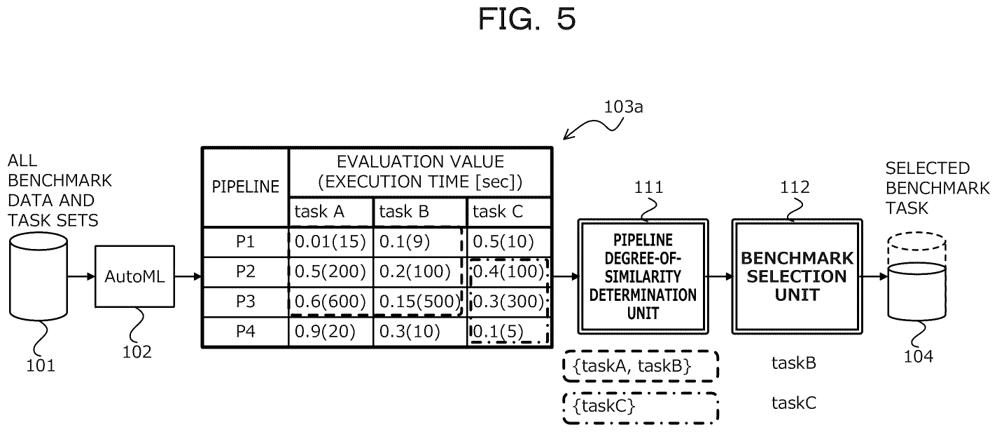

The benchmark extraction unit 112b extracts, as a benchmark task 104 (to be described later using FIG. 5), a task having a shortest execution time, from among the tasks of each group sorted by the execution time sort unit 112a.

FIG. 5 is a diagram for describing task control processing according to the embodiment.

As illustrated in FIG. 5, the AutoML 102 outputs an execution result example 103a of all the benchmark tasks based on all the benchmark data and task sets 101.

The pipeline degree-of-similarity determination unit 111 sets, as the identical group, the tasks having the same top N pipelines, among pipelines having good evaluation values. In the example illustrated in FIG. 5, tasks A, B, and C for which the task is regression are root mean squared error (RMSE; closer to 0 is better).

In the example illustrated in the execution result example 103a of FIG. 5, evaluation values of pipelines P1, P2, and P3 of the task A are 0.01, 0.5, and 0.6, respectively, and evaluation values of pipelines P1, P2, and P3 of the task B are 0.1, 0.2, and 0.15, respectively. Accordingly, the tasks A and B including top three (N=3) pipelines P1, P2, and P3 having good evaluation values are set as an identical group (see a broken line frame).

Evaluation values of pipeline P2, P3, and P4 of the task C are 0.4, 0.3, and 0.1, respectively. Accordingly, the task C including top three (N=3) pipelines P2, P3, and P4 having good evaluation values is set as an identical group (see a dashed dotted line frame).

The benchmark selection unit 112 selects the task having the shortest execution time from the group created by the pipeline degree-of-similarity determination unit 111.

In the example illustrated in the execution result example 103a of FIG. 5, the task B of which a total value of execution times is 619 [sec] and is the smallest is selected as the benchmark task 104 from a group of {task A, task B}.

The task C of which a total value of execution times is 415 [sec] and is the smallest is selected as the benchmark task 104 from a group of {task C}.

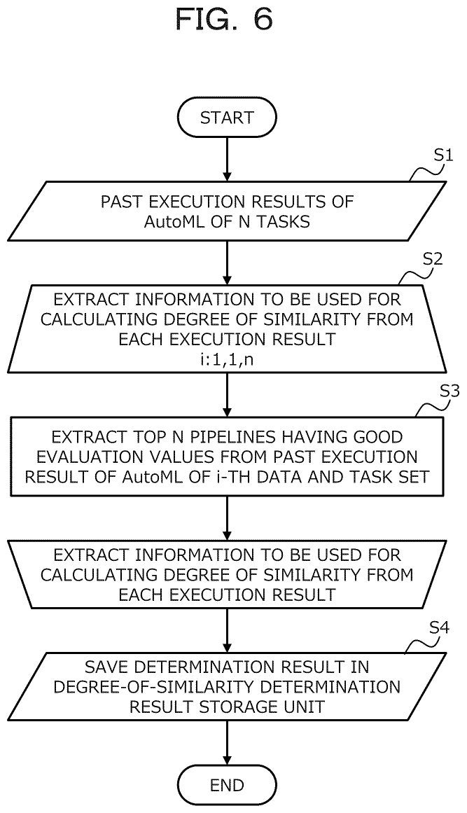

Processing of determining the degrees of similarity of the pipelines according to the embodiment will be described in accordance with a flowchart (steps S1 to S4) illustrated in FIG. 6.

The pipeline degree-of-similarity determination unit 111 acquires the past execution results 103 of the AutoML 102 of n (n is a natural number) tasks (step S1).

From each of the execution results 103, the pipeline degree-of-similarity determination unit 111 repeatedly extracts information to be used for calculating the degrees of similarity (repeatedly executes processing in step S3 at i=1 to n; step S2).

From the past execution results 103 of the AutoML 102 of an i-th data and task set 101, the pipeline degree-of-similarity determination unit 111 extracts top N pipelines having good evaluation values (step S3).

The pipeline degree-of-similarity determination unit 111 saves the determination results of the degrees of similarity in the degree-of-similarity determination result storage unit 141 (step S4). The processing of determining the degrees of similarity of the pipelines is ended.

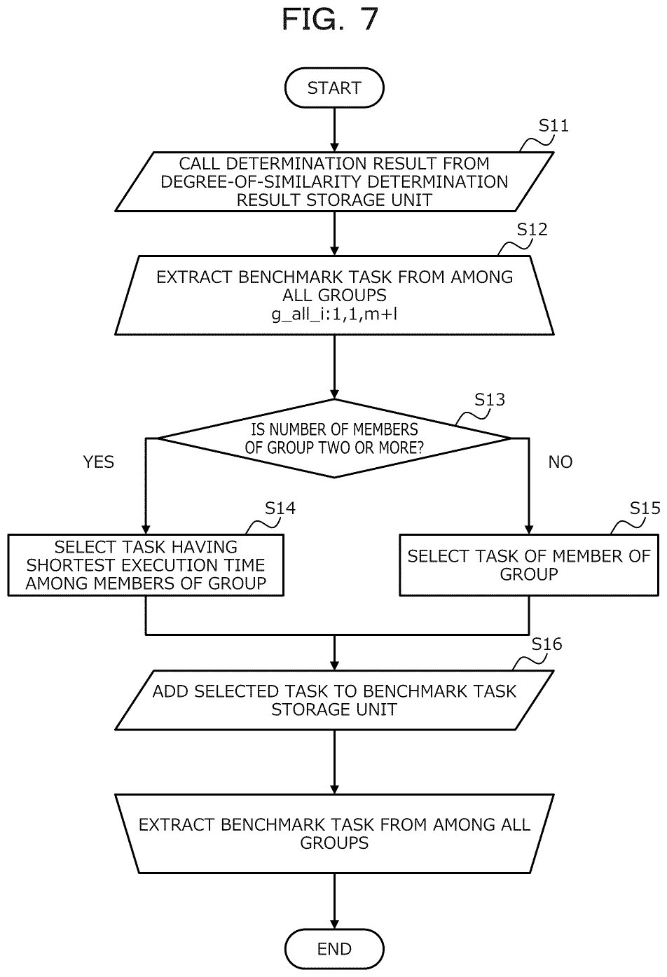

Next, processing of selecting the benchmark according to the embodiment will be described in accordance with a flowchart (steps S11 to S16) illustrated in FIG. 7.

The benchmark selection unit 112 calls the determination result of the degree of similarity from the degree-of-similarity determination result storage unit 141 (step S11).

The benchmark selection unit 112 repeatedly extracts the benchmark task 104 from all the groups (repeatedly executes processing of steps S13 to S16 at g_all_i=1 to m+l; step S12).

The benchmark selection unit 112 determines whether or not the number of members of the group is two or more (step S13).

In a case where the number of members of the group is two or more (see Yes route in step S13), the benchmark selection unit 112 selects a task having a shortest execution time among the members of the group (step S14). The processing proceeds to step S16.

By contrast, in a case where the number of members of the group is not two or more (see No route in step S13), the benchmark selection unit 112 selects the task of the member of the group (step S15).

The benchmark selection unit 112 adds the selected task to the benchmark task storage unit 142 (step S16).

### [B] Modification Example

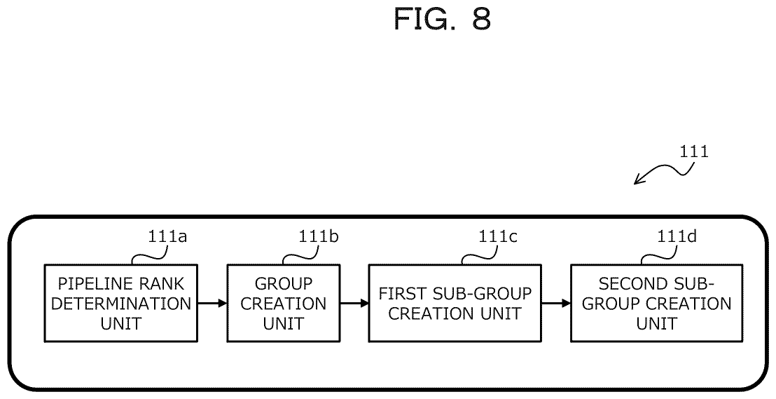

FIG. 8 is a block diagram schematically illustrating a configuration example of the pipeline degree-of-similarity determination unit 111 according to a modification example.

As illustrated in FIG. 8, the pipeline degree-of-similarity determination unit 111 according to the modification example has functions as a first sub-group creation unit 111c and a second sub-group creation unit 111d in addition to the functions as the pipeline rank determination unit 111a and the group creation unit 111b.

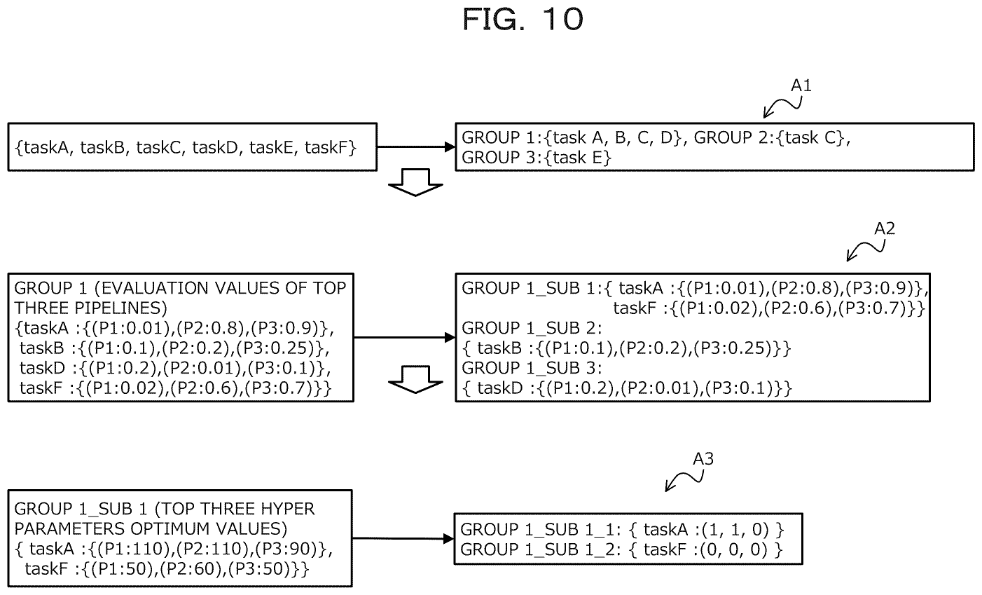

The first sub-group creation unit 111c creates a sub-group from the deviation between the evaluation values of the pipelines. Details of the function of the first sub-group creation unit 111c will be described later using FIG. 10 and the like.

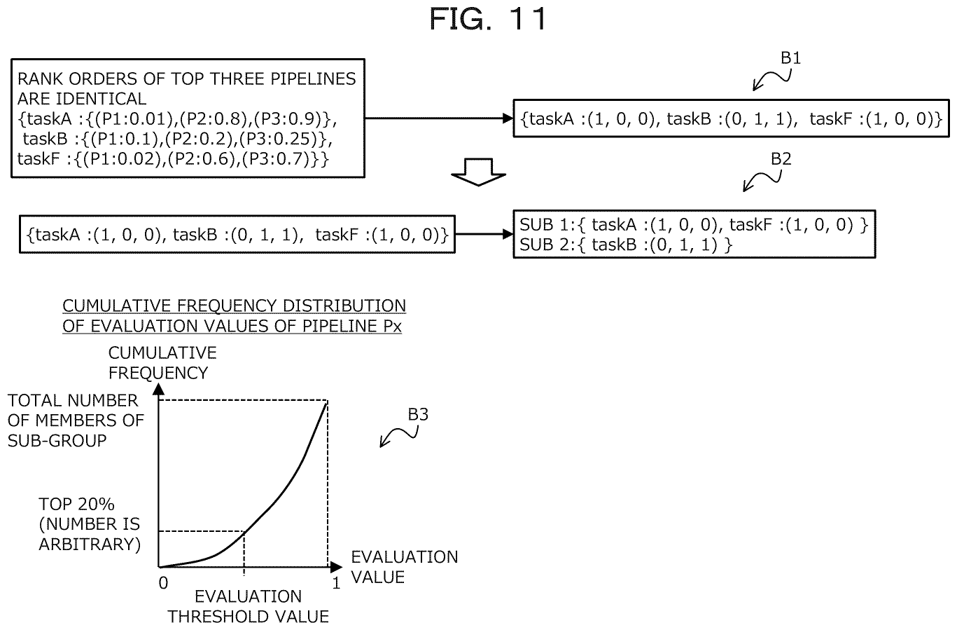

The second sub-group creation unit 111d creates sub-groups based on the degrees of similarity of the optimum values of the hyper parameters of the machine learning model. Details of the function of the second sub-group creation unit 111d will be described later using FIG. 11 and the like.

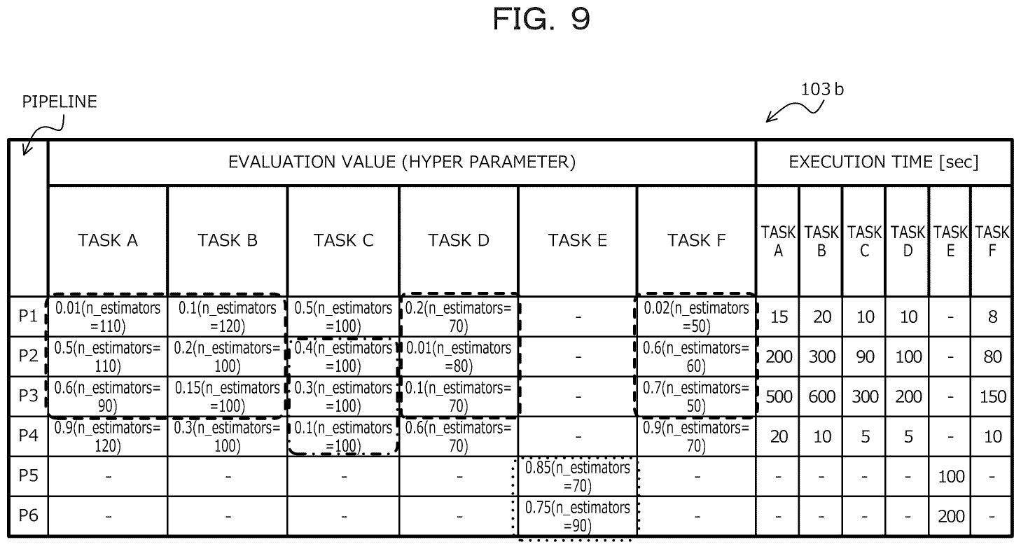

FIG. 9 is a table representing an execution result example 103b of all benchmark tasks according to the modification example.

In the example illustrated in FIG. 9, tasks A, B, C, and D for which the task is regression are RMSE (closer to 0 is better), and a task E for which the task is classifier is F1 (closer to 1 is better).

N_estimators in each task is an example of a hyper parameter that is a setting value adjustable in the machine learning model, and represents the number of trees to be used for estimation.

In the example illustrated in the execution result example 103b of FIG. 9, evaluation values of pipelines P1, P2, and P3 of the task A are 0.01, 0.5, and 0.6, respectively, and evaluation values of pipelines P1, P2, and P3 of the task B are 0.1, 0.2, and 0.15, respectively. Evaluation values of pipelines P1, P2, and P3 of the task D are 0.2, 0.01, and 0.1, respectively, and evaluation values of pipelines P1, P2, and P3 of a task F are 0.02, 0.6, and 0.7, respectively. Accordingly, the tasks A, B, D, and F including the top three (N=3) pipelines P1, P2, and P3 having good evaluation values are set as an identical group (see a broken line frame).

Evaluation values of pipeline P2, P3, and P4 of the task Care 0.4, 0.3, and 0.1, respectively. Accordingly, the task C including top three (N=3) pipelines P2, P3, and P4 having good evaluation values is set as an identical group (see a dashed dotted line frame).

Evaluation values of pipelines P5 and P6 of the task E are 0.85 and 0.75, respectively. Accordingly, the task E including top three (N=3) pipelines P5 and P6 having good evaluation values are set as an identical group (see a dotted line frame).

FIG. 10 is a diagram for describing processing of determining the degrees of similarity of the pipelines according to the modification example.

The pipeline degree-of-similarity determination unit 111 creates a group by tasks in which top N (N>1) pipelines having the good evaluation values are the same. For example, in a case where N=3, the tasks A, B, D, and F in which the top three pipelines are the same are set as an identical group.

In reference sign A1, grouping of group 1:{task A, B, D, F}, group 2:{task C}, and group 3:{task E} is performed from {task A, task B, task C, task D, task E, task F}.

The pipeline degree-of-similarity determination unit 111 uses, as the degree of similarity, the evaluation value of the pipeline of each task and the deviation thereof, and further performs sub-grouping (details will be described later using FIG. 11). For example, since a rank order of the task D is P2, P3, and P1 and rank orders of tasks A, B, and F are P1, P2, and P3, the tasks belong to different sub-groups. The evaluation values of the tasks A and F are specialized to P1, and the evaluation values of the task B are approximately the same in all the pipelines. In this case, the tasks A and F and the task B belong different sub-groups.

In reference sign A2, group 1 is divided into sub-groups of group 1_sub 1:{task A:{(P1:0.01), (P2:0.8), (P3:0.9)}, task F:{(P1:0.02), (P2:0.6), (P3:0.7)}}, group 1_sub 2:{task B:{(P1:0.1), (P2:0.2), (P3:0.25)}}, and group 1_sub 3:{task D:{(P1:0.2), (P2:0.01), (P3:0.1)}}.

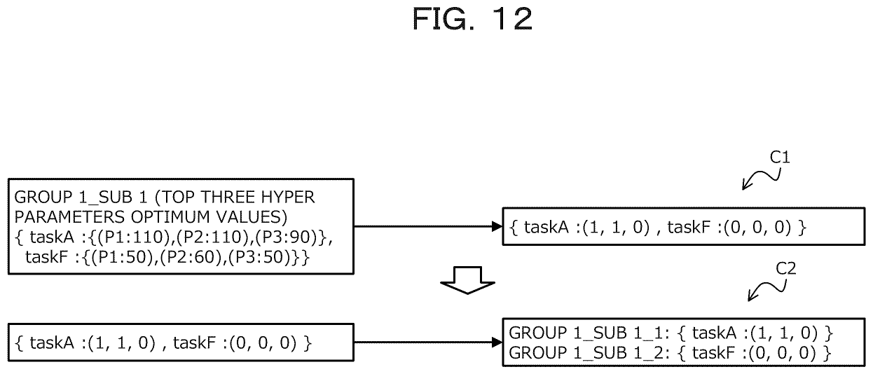

Among the groups created in reference sign A2, the pipeline degree-of-similarity determination unit 111 further creates sub-groups based on the degrees of similarity of the optimum values of the hyper parameters of the machine learning model (details will be described later using FIG. 12). For example, the task A tends to have a large optimum value of n_estimators, and the task F tends to have a small optimum value of n_estimators. In this case, the task A and the task F belong to different sub-groups.

In reference sign A3, group 1_sub 1 is divided into sub-groups of group 1_sub 1_1:{task A:(1, 1, 0)}, and group 1_sub 1_2:{task F:(0, 0, 0)}.

The benchmark selection unit 112 selects the task having the shortest execution time from the group created by the pipeline degree-of-similarity determination unit 111.

In a series of procedures, at a stage where the number of members of the sub-group becomes 1, the processing related to the sub-group is ended.

FIG. 11 is a diagram for describing processing of creating a sub-group from the deviation between the evaluation values of the pipelines according to the modification example.

The first sub-group creation unit 111c creates a sub-group from the deviation between the evaluation values of the pipelines. The evaluation value of each pipeline is converted into a binary value depending on whether the evaluation value is better than an evaluation threshold value. For example, in a case where an evaluation threshold value of the pipeline P1 is 0.1, an evaluation threshold value of the pipeline P2 is 0.5, and an evaluation threshold value of the pipeline P3 is 0.5, {task A:(1, 0, 0), task B:(0, 1, 1), task F:(1, 0, 0)} is output as indicated by reference sign B1.

The first sub-group creation unit 111c sets tasks of which the converted values are identical as an identical sub-group. As indicated by reference sign B2, the tasks A, B, and F are divided into sub-groups of sub-1:{task A:(1, 0, 0), task F:(1, 0, 0)}, sub-2:{task B:(0, 1, 1)}.

As indicated by reference sign B3, the evaluation threshold value may be determined from, for example, a cumulative frequency distribution of the evaluation values of the pipelines. It is difficult for an empirically generated pipeline to have high evaluation performance, and when a plurality of pipelines are compared, it is highly likely that a pipeline having markedly good performance is a pipeline that is well fitted to input data. Accordingly, as indicated by reference sign B3, the evaluation threshold value is set to a percentage (for example, 20%) from the top.

FIG. 12 is a diagram for describing the processing of creating the sub-group based on the degrees of similarity of the optimum values of the hyper parameters of the machine learning model according to the modification example.

The second sub-group creation unit 111d further creates sub-groups based on the degrees of similarity of the optimum values of the hyper parameters of the machine learning model. The hyper parameter optimum value of each pipeline is converted into a binary value depending on whether the hyper parameter optimum value is larger or smaller than a hyper parameter threshold value.

For example, in a case where a hyper parameter threshold value of the pipeline P1 is 100, a hyper parameter threshold value of the pipeline P2 is 100, and a hyper parameter threshold value of the pipeline P3 is 100, {task A:(1, 1, 0), task F:(0, 0, 0)} is output as indicated by reference sign C1.

The second sub-group creation unit 111d sets tasks of which the converted values are identical as an identical sub-group. As indicated by reference sign C2, each of the tasks A and F is divided into sub-groups of group 1_sub 1_1:{task A:(1, 1, 0)} and group 1_sub 1_2:{task F:(0, 0, 0)}.

Although the hyper parameter threshold value is arbitrary value, for example, a default value of the hyper parameter optimum value may be used. The default value may be acquired from a model library of machine learning. In this case, the threshold value may be automatically set by specifying a model of the pipeline and acquiring a default value from an application programming interface (API) of the model. For example, the hyper parameter threshold value may be a default value of n_estimators of RandomForestClassifier.

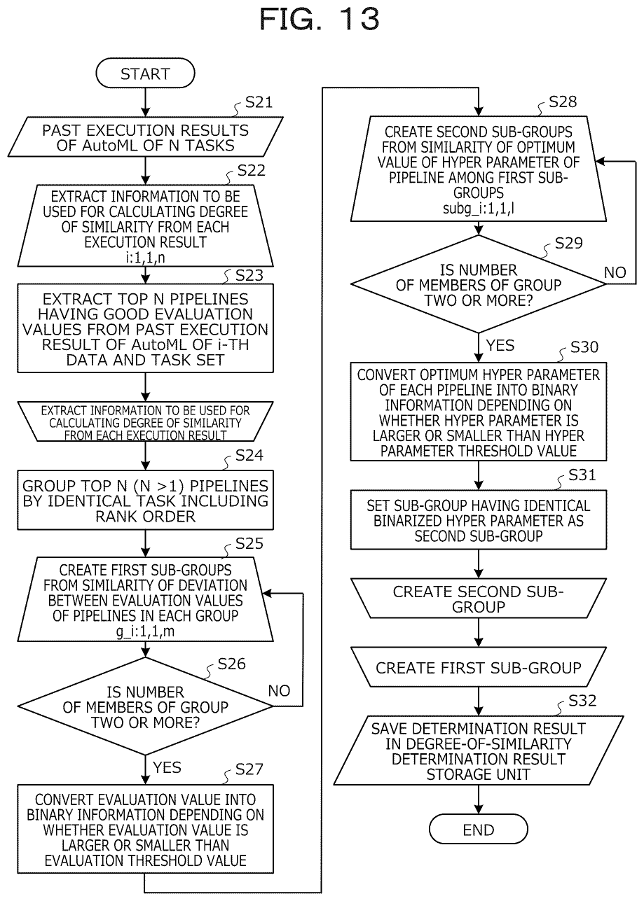

The processing of determining the degrees of similarity of the pipelines according to the modification example will be described in accordance with a flowchart (steps S21 to S32) illustrated in FIG. 13.

The pipeline degree-of-similarity determination unit 111 acquires the past execution results 103 of the AutoML 102 of n tasks (step S21).

From each of the execution results 103, the pipeline degree-of-similarity determination unit 111 repeatedly extracts the information to be used for calculating the degrees of similarity (repeatedly executes processing in step S23 for i=1 to n; step S22).

From the past execution results 103 of the AutoML 102 of the i-th data and task set, the pipeline degree-of-similarity determination unit 111 extracts top N pipelines having good evaluation values (step S23).

The pipeline degree-of-similarity determination unit 111 groups the top N (N>1) pipelines by the identical task including the rank order (step S24).

The pipeline degree-of-similarity determination unit 111 repeatedly creates a first sub-group from the similarity of the deviation between the evaluation values of the pipelines in each group (repeatedly executes processing of steps S26 to S31 for g_i=1 to m; step S25).

The pipeline degree-of-similarity determination unit 111 determines whether or not the number of members of the group is two or more (step S26).

In a case where the number of members of the group is not two or more (see No route in step S26), the processing returns to step S25.

By contrast, in a case where the number of members of the group is two or more (see Yes route in step S26), the pipeline degree-of-similarity determination unit 111 converts the evaluation value into binary information depending on whether the evaluation value is larger or smaller than the evaluation threshold value (step S27).

The pipeline degree-of-similarity determination unit 111 repeatedly creates a second sub-group from the similarities of the optimum values of the hyper parameters of the pipelines in the first sub-group (repeatedly executes the processing in steps S29 to S31 for subg_i=1 to l; step S28).

The pipeline degree-of-similarity determination unit 111 determines whether or not the number of members of the group is two or more (step S29).

In a case where the number of members of the group is not two or more (see No route in step S29), the processing returns to step S28.

By contrast, in a case where the number of members of the group is two or more (see Yes route in step S29), the pipeline degree-of-similarity determination unit 111 converts an optimum hyper parameter of each pipeline into binary information depending on whether the hyper parameter is larger or smaller than the hyper parameter threshold value (step S30).

For example, the pipeline degree-of-similarity determination unit 111 sets the sub-groups having the identical binarized hyper parameter as the second sub-group (step S31).

The pipeline degree-of-similarity determination unit 111 saves the determination results of the degrees of similarity in the degree-of-similarity determination result storage unit 141 (step S32). The processing of determining the degrees of similarity of the pipelines according to the modification example is ended.

### [C] Effects

According to the task control program, the information processing apparatus, and the task control method according to the embodiment described above, for example, the following operations and advantages may be achieved.

The pipeline degree-of-similarity determination unit 111 executes AutoML processing on each of a plurality of tasks to acquire a plurality of pipelines for each of the plurality of tasks. The pipeline degree-of-similarity determination unit 111 classifies the plurality of tasks into a plurality of groups based on similarities of one or more pipelines selected based on evaluation values, among the plurality of pipelines, and similarities of evaluation values of the one or more pipelines. The benchmark selection unit 112 generates a task group by selecting one task from each of the plurality of groups based on an execution time of the AutoML processing of each of the plurality of tasks.

Accordingly, it is possible to generate a benchmark from which data and a task having an overlapping property as viewed from the AutoML are deleted while maintaining the variety of data and tasks, and it is possible to shorten a time for evaluating the generalization performance of the AutoML.

The one task is a task that has a smallest total value of the execution times in a group to which the one task belongs, among the plurality of groups.

Accordingly, an appropriate task group having a short execution time may be generated.

The pipeline degree-of-similarity determination unit 111 further classifies the plurality of groups into a plurality of first sub-groups based on a deviation between the evaluation values in the one or more pipelines.

Accordingly, the generation of the task group is accurately performed.

The pipeline degree-of-similarity determination unit 111 further classifies the plurality of first sub-groups into a plurality of second sub-groups based on degrees of similarity of hyper parameters of a machine learning model.

Accordingly, it is possible to more accurately generate the task group.

### [D] Others

The disclosed technique is not limited to the embodiment described above, and may be carried out by variously modifying the technique within a range not departing from the gist of the present embodiment. Each of the configurations and each of the processes of the present embodiment may be employed or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a task control program for causing a computer to execute a process comprising:
executing automated machine learning (AutoML) processing on each of a plurality of tasks to acquire a plurality of pipelines for each of the plurality of tasks;
classifying the plurality of tasks into a plurality of groups based on similarities of one or more pipelines selected based on evaluation values, among the plurality of pipelines, and similarities of evaluation values of the one or more pipelines; and
generating a task group by selecting one task from each of the plurality of groups based on an execution time of the AutoML processing of each of the plurality of tasks.

2. The non-transitory computer-readable recording medium according to claim 1, wherein
the one task is a task that has a smallest total value of the execution times in a group to which the one task belongs, among the plurality of groups.

3. The non-transitory computer-readable recording medium according to claim 1, wherein
the computer is caused to execute a process of further classifying the plurality of groups into a plurality of first sub-groups based on a deviation between the evaluation values in the one or more pipelines.

4. The non-transitory computer-readable recording medium according to claim 3, wherein
the computer is caused to execute a process of further classifying the plurality of first sub-groups into a plurality of second sub-groups based on degrees of similarity of hyper parameters of a machine learning model.

5. An information processing apparatus comprising:
a memory; and
a processor coupled to the memory and configured to:
execute automated machine learning (AutoML) processing on each of a plurality of tasks to acquire a plurality of pipelines for each of the plurality of tasks;
classify the plurality of tasks into a plurality of groups based on similarities of one or more pipelines selected based on evaluation values, among the plurality of pipelines, and similarities of evaluation values of the one or more pipelines; and
generate a task group by selecting one task from each of the plurality of groups based on an execution time of the AutoML processing of each of the plurality of tasks.

6. The information processing apparatus according to claim 5, wherein
the one task is a task that has a smallest total value of the execution times in a group to which the one task belongs, among the plurality of groups.

7. The information processing apparatus according to claim 5, wherein
the processor executes a process of further classifying the plurality of groups into a plurality of first sub-groups based on a deviation between the evaluation values in the one or more pipelines.

8. The information processing apparatus according to claim 7, wherein
the processor executes a process of further classifying the plurality of first sub-groups into a plurality of second sub-groups based on degrees of similarity of hyper parameters of a machine learning model.

9. A task control method for causing a computer to execute a process comprising:
executing automated machine learning (AutoML) processing on each of a plurality of tasks to acquire a plurality of pipelines for each of the plurality of tasks;
classifying the plurality of tasks into a plurality of groups based on similarities of one or more pipelines selected based on evaluation values, among the plurality of pipelines, and similarities of evaluation values of the one or more pipelines; and
generating a task group by selecting one task from each of the plurality of groups based on an execution time of the AutoML processing of each of the plurality of tasks.

10. The task control method according to claim 9, wherein
the one task is a task that has a smallest total value of the execution times in a group to which the one task belongs, among the plurality of groups.

11. The task control method according to claim 9, further comprising:
executing a process of further classifying the plurality of groups into a plurality of first sub-groups based on a deviation between the evaluation values in the one or more pipelines.

12. The task control method according to claim 11, further comprising:
executing a process of further classifying the plurality of first sub-groups into a plurality of second sub-groups based on degrees of similarity of hyper parameters of a machine learning model.
